(19) United States
(12) Patent Application Publication
(10) Pub. No.: US 2021/0209481 A1
(43) Pub. Date: Jul. 8, 2021

(54) METHODS AND SYSTEMS FOR DYNAMIC SERVICE PERFORMANCE PREDICTION USING TRANSFER LEARNING

(71) Applicant: Telefonaktiebolaget LM Ericsson (publ), Stockholm (SE)

(72) Inventors: Farnaz MORADI, STOCKHOLM (SE); Andreas JOHNSSON, UPPSALA (SE); Christofer FLINTA, STOCKHOLM (SE); Jawwad AHMED, KISTA (SE); Rolf STADLER, STOCKHOLM (SE)

(21) Appl. No.: 17/257,876

(22) PCT Filed: Jul. 5, 2019
(86) PCT No.: PCT/SE2019/050672

§ 371 Date: Jan. 5, 2021

Related U.S. Application Data
(60) Provisional application No. 62/694,583, filed on Jul. 6, 2018.

(51) Int. Cl. G06N 5/00; G06N 3/04; G06N 20/00

(52) U.S. Cl. CPC G06N 5/003; G06N 20/00; G06N 3/04

(57) ABSTRACT

Systems and methods are provided for generating a data driven target model associated with a service having a first configuration. The method including: determining if there is an existing data driven source model for the service having a second configuration which is different from the first configuration; wherein if there is an existing data driven source model, determining whether a level of differences between the first configuration and the second configuration enables the existing data driven source model to be used as a source model for the data driven target model being generated; wherein if there is no existing data driven source model or if the level of differences for the existing data driven source model does not enable the existing data driven source model for the first configuration to be used, then requesting a source domain.

### TECHNICAL FIELD

The present invention generally relates to communication networks and, more particularly, to mechanisms and techniques for dynamic service performance prediction using transfer learning.

### BACKGROUND

Over time the number of products and services provided to users of telecommunication products has grown significantly. For example, in the early years of wireless communication, devices could be used for conversations and later also had the ability to send and receive text messages. Over time, technology advanced and wireless phones of varying capabilities were introduced which had access to various services provided by network operators, e.g., data services, such as streaming video or music service. More recently there are numerous devices, e.g., so called “smart” phones and tablets, which can access communication networks in which the operators of the networks, and other parties, provide many different types of services, applications, etc.

Service providers need to be able to deliver services under strict Service Level Agreements (SLAs). Therefore, it is desirable to predict the performance of the service operating in a dynamically changing environment, e.g., a cloud environment. Performance prediction use cases include service on boarding, anomaly detection, scaling, bottleneck detection and root-cause analysis.

The performance of a cloud service depends on the current load and the resources allocated to the service. In a cloud environment, service load is often highly dynamic. Additionally, the allocated resources may change during operation due to scaling and migration. Many cloud-based services are implemented using microservices architecture. Microservices can dynamically change, in terms of both resources and configuration. For example, microservice containers can be started, stopped and move both frequently and dynamically. Applications can also change frequently as, for example, operators aim to shorten development cycles which leads to an increase in deployment frequency. Accordingly, predicting service performance needs to take into account these dynamic factors.

The performance of a service and conformance and/or violation of an SLA can be predicted using machine learning. However, learning the performance in an operational environment is not practical, because collecting training data from an operational environment requires extensive measurements which can adversely affect the service. One solution to this problem can be to use transfer learning.

In recent years, transfer learning has received considerable attention, specifically in areas such as image, video and sound recognition. In traditional machine learning, each task is learned from scratch using training data obtained from a domain and making predictions for data from the same domain. However, sometimes there is not a sufficient amount of data for training in the domain of interest. In these cases, transfer learning can be used to transfer knowledge from a domain where sufficient training data is available to the domain of interest in order to improve the accuracy of the machine learning task.

Transfer learning can be described as follows. Given a source domain (DS) and learning task (TS), a target domain (DT) and learning task (TT), transfer learning aims to help improve the learning of the target predictive function fT(·) in DT using the knowledge in DS and TS, where DS≠DT, or TS≠TT.

An example of transfer learning is to develop a machine learning model for recognizing a specific object in a set of images. The source domain corresponds to the set of images and the learning task is set to recognize the object itself. Modeling a second learning task, e.g., recognizing a second object in the original set of images, corresponds to a transfer learning case where the source domain and the target domains are the same, while the learning task differs.

Another example involving transfer learning is to develop a machine learning model for image recognition using natural images, e.g., images from ImageNet, and then transferring the features learned from the source domain to perform image recognition on magnetic resonance imaging (MRI) images which is a different target domain.

Previous studies have shown that transfer learning can be used for performance modeling of configurable software. For example, in “Portable workload performance prediction for the cloud (U.S. Pat. No. 9,111,232 B2)”, a database performance model is learned on a test server for a given set of training workloads and under different resource constraints. The learned model is then used to predict database performance in the cloud. Collaborative filtering is used for comparing a workload with reference workload and machine learning is used to map test server performance to the corresponding performance in the cloud. For each new workload, it has to run on the test server to learn a model. The method can adapt to workload changes, by iteratively executing the workload at a selected configuration on the test server. However, the solution does not consider the configuration changes due to the dynamically changing cloud environment.

In “Prediction-based provisioning planning for cloud environments (U.S. Pat. No. 9,363,154 B2)”, performance of a system including a plurality of server tiers is predicted. This patent relates to provisioning planning where the provisioning manager identifies the most cost-effective provisioning plan for a given performance goal. First the performance is learned on an over provisioned deployment of the application, then the performance is predicted for different deployments until the most cost effective one is identified.

In “Method and Apparatus for Predicting Application Performance Across Machines with Different Hardware Configurations (US 20110320391 A1)”, simulation is used to simulate different hardware configurations and building a model for application performance. The application performance is also obtained from actual machines with different hardware configurations. The final predictive model is then learned which has a higher accuracy than the model based on simulation.

Some of the existing solutions aim at benchmarking the application and building a model by using extensive measurements. However, performing extensive measurements in an operational domain can be very costly and can also adversely affect the performance of the running service. Additionally, existing solutions do not describe how they can be used in a fully automated system in a dynamically changing environment. Further, some solutions also depend on a separate testbed or a simulator of the environment.

Thus, there is a need to provide methods and systems that overcome the above-described drawbacks associated with models of services operating in a dynamically changing environment.

### SUMMARY

Embodiments allow for administrating and dynamically relearning data driven models of services operating in a dynamically changing environment, e.g., a cloud environment. These embodiments can be advantageous by using transfer learning to reduce the learning time, to increase the prediction accuracy and/or to reduce overhead related to building data driven models.

According to an embodiment, there is a method for generating a data driven target model associated with a service having a first configuration. The method including: determining if there is an existing data driven source model for the service having a second configuration which is different from the first configuration; wherein if there is an existing data driven source model, determining whether a level of differences between the first configuration and the second configuration enables the existing data driven source model to be used as a source model for the data driven target model being generated; wherein if there is no existing data driven source model or if the level of differences for the existing data driven source model does not enable the existing data driven source model for the first configuration to be used, then requesting a source domain, wherein the source domain is a scaled down version of a target domain and learning the source model using the source domain; obtaining a number of samples from the target domain which is associated with the service; and using transfer learning to learn the data driven target model in the target domain using the source model and the obtained number of samples.

According to an embodiment, there is a communication node for generating a data driven target model associated with a service having a first configuration. The communication node including: a processor configured to determine if there is an existing data driven source model for the service having a second configuration which is different from the first configuration; wherein if there is an existing data driven source model, the processor determines whether a level of differences between the first configuration and the second configuration enables the existing data driven source model to be used as a source model for the data driven target model being generated; wherein if there is no existing data driven source model or if the level of differences for the existing data driven source model does not enable the existing data driven source model for the first configuration to be used, then the processor requests a source domain, wherein the source domain is a scaled down version of a target domain and learning the source model using the source domain; wherein the processor is configured to obtain a number of samples from the target domain which is associated with the service; and wherein the processor is further configured to use transfer learning to learn the data driven target model in the target domain using the source model and the obtained number of samples.

According to an embodiment, there is a computer-readable storage medium containing a computer-readable code that when read by a processor causes the processor to perform a method for generating a data driven target model associated with a service having a first configuration. The method including: determining if there is an existing data driven source model for the service having a second configuration which is different from the first configuration; wherein if there is an existing data driven source model, determining whether a level of differences between the first configuration and the second configuration enables the existing data driven source model to be used as a source model for the data driven target model being generated; wherein if there is no existing data driven source model or if the level of differences for the existing data driven source model does not enable the existing data driven source model for the first configuration to be used, then requesting a source domain, wherein the source domain is a scaled down version of a target domain and learning the source model using the source domain; obtaining a number of samples from the target domain which is associated with the service; and using transfer learning to learn the data driven target model in the target domain using the source model and the obtained number of samples.

According to an embodiment, there is an apparatus adapted to determine if there is an existing data driven source model for the service having a second configuration which is different from the first configuration; wherein if there is an existing data driven source model, the apparatus is adapted to determine whether a level of differences between the first configuration and the second configuration enables the existing data driven source model to be used as a source model for the data driven target model being generated; wherein if there is no existing data driven source model or if the level of differences for the existing data driven source model does not enable the existing data driven source model for the first configuration to be used, then the apparatus is adapted to request a source domain, wherein the source domain is a scaled down version of a target domain and learning the source model using the source domain; the apparatus being adapted to obtain a number of samples from the target domain which is associated with the service; and adapted to use transfer learning to learn the data driven target model in the target domain using the source model and the obtained number of samples.

According to an embodiment, there is an apparatus including: a first module configured to determine if there is an existing data driven source model for the service having a second configuration which is different from the first configuration; wherein if there is an existing data driven source model, the first module is configured to determine whether a level of differences between the first configuration and the second configuration enables the existing data driven source model to be used as a source model for the data driven target model being generated; wherein if there is no existing data driven source model or if the level of differences for the existing data driven model does not enable the existing data driven source model for the first configuration to be used, then the first module is configured to request a source domain, wherein the source domain is a scaled down version of a target domain and learning the source model using the source domain, a second module configured to obtain a number of samples from the target domain which is associated with the service; and a third module configured to use transfer learning to learn the data driven target model in the target domain using the source model and the obtained number of samples.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 depicts an architecture which can support various use cases according to an embodiment;

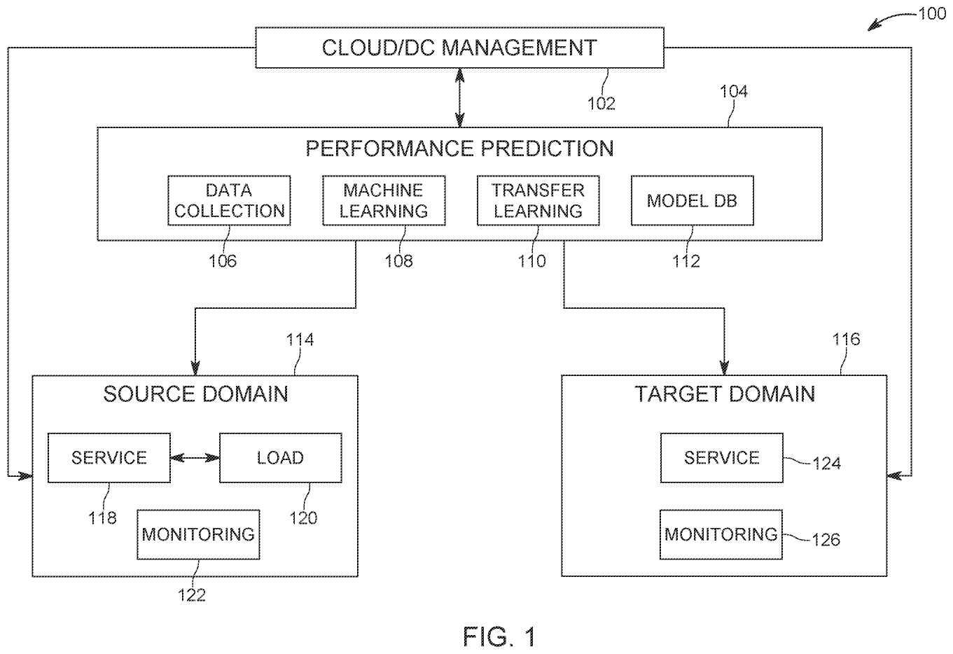

FIG. 2 depicts a flowchart of a method including steps associated with re-visiting a data driven model according to an embodiment;

FIG. 3 show a flowchart of a method for learning a data driven model using a source domain according to an embodiment;

FIG. 4 depicts a flowchart of a method for determining a transfer method according to an embodiment;

FIG. 5 illustrates a neural network according to an embodiment;

FIG. 6 shows a flowchart of a method for how a number of layers to re-trained associated with the neural network can be identified according to an embodiment;

FIG. 7 shows a flowchart of a method for generating a data-driven model according to an embodiment;

FIG. 8 depicts a computing environment according to an embodiment; and

FIG. 9 depicts an electronic storage medium on which computer program embodiments can be stored.

### DETAILED DESCRIPTION

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details disclosed below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on computer-readable storage medium and when the instructions are executed by a computer or other suitable processor control, the computer or processor performs the functions.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in a non-transitory computer readable medium and so executed by a computer or processor, whether or not such computer or processor is explicitly shown.

The functions of the various elements including functional blocks, including but not limited to those labeled or described as “computer”, “processor” or “controller” may be provided through the use of hardware such as circuit hardware and/or hardware capable of executing software in the form of coded instructions stored on computer readable medium. Thus, such functions and illustrated functional blocks are to be understood as being hardware-implemented and/or computer-implemented, (e.g., machine-implemented).

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions.

In terms of computer implementation, a computer is generally understood to comprise one or more processors, or one or more controllers, and the terms computer and processor and controller may be employed interchangeably herein. When provided by a computer, processor, or controller, the functions may be provided by a single dedicated computer, processor, or controller, by a single shared computer, processor, or controller, or by a plurality of individual computers, processors, or controllers, some of which may be shared or distributed. Moreover, use of the term “processor” or “controller” shall also be construed to refer to other hardware capable of performing such functions and/or executing software, such as the example hardware recited above.

The technology may be used in any type of cellular radio communications (e.g., GSM, CDMA, 3G, 4G, 5G, etc.). For ease of description, the term user equipment (UE) encompasses any kind of radio communications terminal/device, mobile station (MS), PDAs, cell phones, laptops, etc.

As described in the Background section, there are problems associated with dynamic service performance prediction. Embodiments described herein provide systems and methods for administrating and dynamically relearning data driven models of services operating in a dynamically changing environment. Examples of data driven models include performance models, general anomaly detection models and/or root cause analysis models. Although the following embodiments focus on service performance models, those skilled in the art will appreciate that the embodiments can be applied to other data driven models. Prior to describing the various embodiments in detail, an architecture on which these embodiments can be executed will first be described.

According to an embodiment, there is an architecture 100 for operating in a dynamically changing environment. The architecture 100 includes a dynamically changing (DC) system 102 (which can also be a cloud management system). It is to be understood that the system 102 manages the dynamic environment associated with the cloud or other DC environments. The DC system 102 can include a performance prediction module 104 with both a source domain 114 and a target domain 116 which are part of the dynamic environment and deployed by the DC system 102. Test (source) and operational (target) domains can be created through various functionality in, e.g., Openstack or Kubernetes. The performance prediction module 104 collects training data by deploying different load patterns and monitoring in the source domain 114 to learn the performance models. The performance prediction module 104 includes a data collection module 106, a machine learning module 108, a transfer learning module 110 and a model database (DB) 112. The performance prediction module 104 also collects monitoring data from the target domain 116 in order to train the target model.

In this description, various terms are used with respect to models and can be interchanged in various ways depending on the associated context which is understandable to one skilled in the art. For example, a performance model is an example of a data driven model. A performance model, under the correct circumstances, can be a source model. Under other circumstance, the performance model can be an example of a target model. A source can also be a testbed, while a target model can also be an operational model. These examples are intended to help the reader and are not to be considered limiting.

The source domain 114 includes a service module 118, a load module 120 and monitoring module 122. The target domain 116 includes a service module 124 and a monitoring module 126. The service module 118, 124 is a function that can deploy a version of the service expected to run in the target domain 116. For example, the service module 118 could trigger instantiation of a Voice over Long-Term Evolution (VoLTE) application, a data base for end users, or something else. The load module 120 could be described as a benchmarking tool that evaluates the performance of the service under different usage patterns. The monitoring module 122, 126 is a function that can monitor the service performance, and also other statistics (e.g. central processing unit (CPU), memory, network counters) from the cloud environment during execution of the service. Monitoring data can be obtained from different tools, for example, a Linux System Activity Report (SAR) tool.

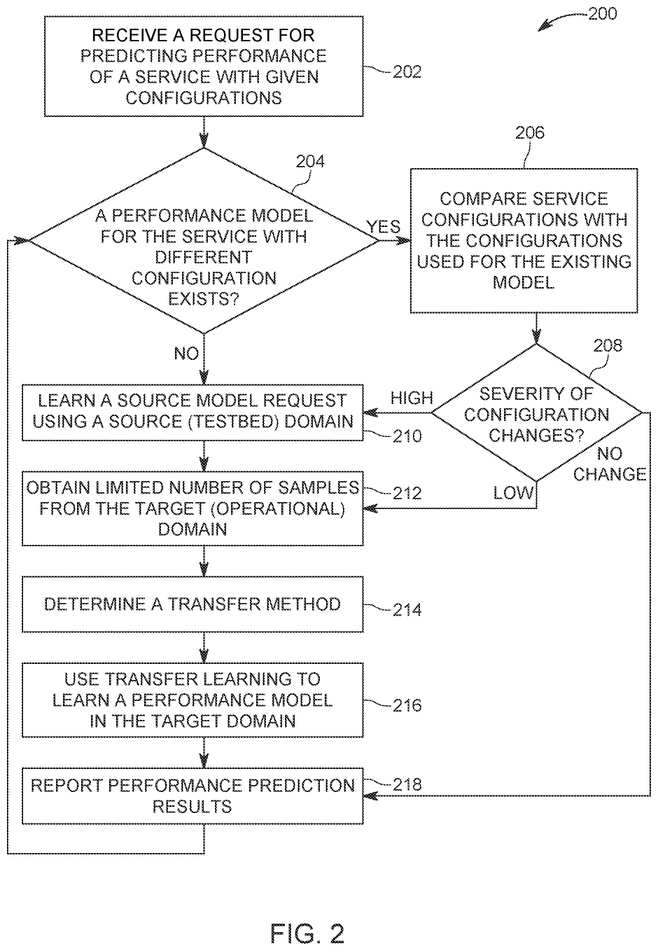

According to an embodiment, FIG. 2 shows a flowchart 200 of a method for the process that occurs according to an embodiment when a performance model needs to be revisited, i.e., when a new service is deployed or the deployment of a currently running service is updated. If a performance model for the current service already exists, e.g., previously learned on a source domain, then the model can be used as the basis for transfer learning. If such a model does not exist, a source domain will be requested. The source domain can be a duplicate of the operational domain (for small-scale services). However, for large-scale services, the requested domain can be a smaller-scale version of the service. For example, in order to predict the performance of a distributed database service consisting of N nodes in the target domain, the source domain can include only one or two nodes. The transfer learning then allows the performance model learned on a smaller scale deployment to be used for learning a larger scale deployment.

More specifically, in step 202, a request for predicting performance of a service with a given set of service configurations is received. According to an embodiment, these service configurations can include information about the service, the workload and the environment, such as resources reserved, distribution of service functions, HW and SW configurations. The information about the service can, for example, include the software versions, the application configurations, etc. The workload information can, for example, include information about different load patterns, e.g., periodic, flash crowd, etc. The environment information can, for example, include resource-related information, such as, number of assigned CPU cores, available memory and the like.

In step 204, it is determined if a performance model already exists for the service for which performance prediction was requested, although the existing performance model has different service configurations from the service configurations set forth in the request, e.g., because there has been a change in the dynamic environment in which the service operates. If the determination is a yes, i.e., there is an existing performance model for the service, then in step 206, the two sets of service configurations are compared. That is the set of service configurations in the request are compared with the set of service configurations associated with the existing performance model to determine the differences between the two sets of service configurations.

Then, in step 208, the severity or level of the differences or changes between the service configuration sets is determined. According to an embodiment, in order to determine the severity level of the differences, the configurations for the target domain are compared against the configurations in the source domain. The comparison can be performed using different methods ranging from a simple threshold-based comparison to more complex techniques, e.g., comparing statistical features of samples from the target domain with data used to create source model(s) to determine severity of changes whether the existing performance model can be used as the source model for predicting performance of the service based on the requested service configurations or whether a new source model needs to be learned. Statistical methods for comparison include Kullback-Leibler (KL) divergence, and H-Score.

For example, if only the number of CPU cores change, e.g., the number of CPU cores assigned to the target domain is higher than the number of CPU cores in the source domain, the severity of change is considered to be low. Therefore, a simple transfer method can be applied, where, e.g., a linear function between the source model and target model can be learned. However, if the software used in the service is changed, e.g., a database software is replaced with another database software, then the severity is considered to be high and a new source model needs to be learned. The rules regarding different changes and their severity can be provided in advance by, for example, a subject matter expert.

If there are no changes (or in some cases extremely minor changes), then the flow proceeds from step 208 to step 218, where the performance prediction results are reported.

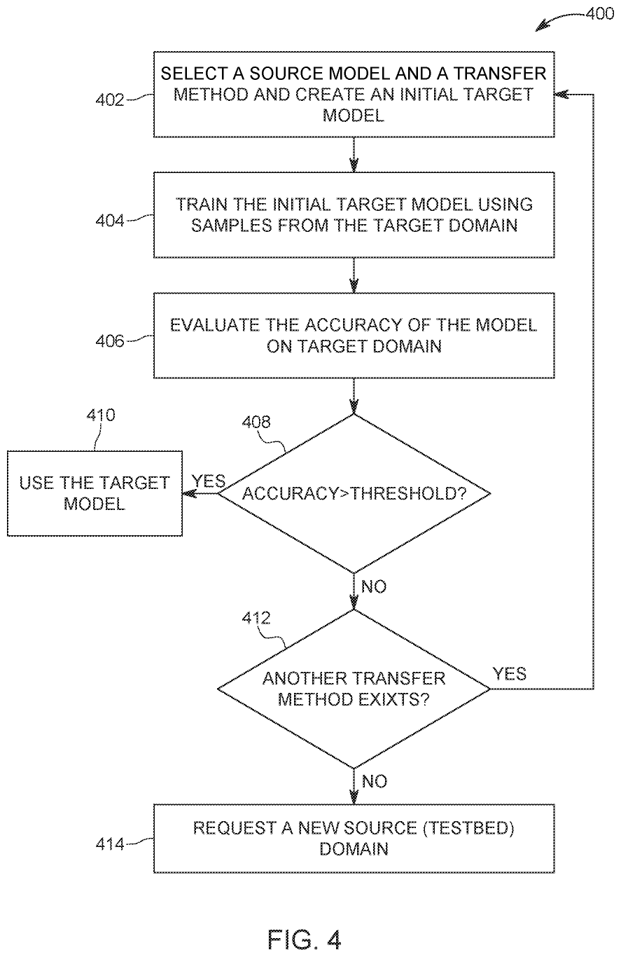

If the severity level of the differences is low, e.g., based on a threshold or one of the other methods described above, then the flow proceeds to step 212, where the existing performance model is selected as the source model and a limited number of samples from the target (operational) domain are obtained. According to an embodiment, while not shown in FIG. 2, the limited number of data samples obtained from the target domain are obtained earlier in the process. Then, in step 214, a transfer learning method is selected. In step 216, the selected transfer learning method is used to learn a performance model in the target domain using the source model and the obtained samples from the target domain, followed by, in step 218, by reporting performance prediction results. Steps 214 and 216 are described in more detail below with respect to FIG. 4.

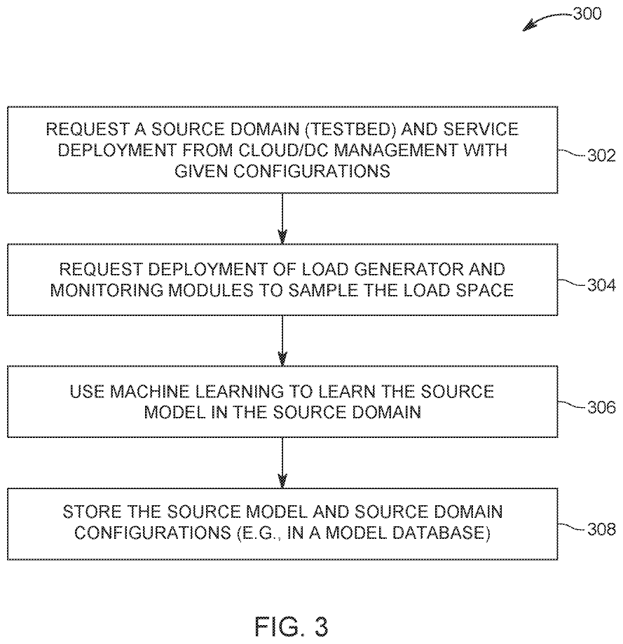

If the, on the other hand, the severity level of the differences between the two service configuration sets is high based, e.g., on the threshold comparison, then the flow instead first proceeds to step 210, where a new source model is learned based on a requested source (e.g., a virtual testbed which can be a virtual instantiation in a cloud environment) domain (this step 210 is shown in more detail with respect to the flowchart 300 shown in FIG. 3). That is, the existing performance model is not used as the source model when the difference level between the requested service configurations and the configurations associated with the existing performance model are too significant. The flow then proceeds as previously described. That is, in step 212, a limited number of samples from the target (operational) domain are obtained. Then, in step 214, a transfer learning method is selected. In step 216, the selected transfer learning method is used to learn a performance model in the target domain using the source model and the obtained samples from the target domain, followed by, in step 218, by reporting performance prediction results. Steps 214 and 216 are described in more detail below with respect to FIG. 4.

If, in step 218, the performance prediction results are below a desired value, then this process can be repeated. According to an embodiment, the desired value for predicted performance is a threshold. The desired threshold value for model performance should be specified for each model and service. If the performance of the model is below this threshold, then a different transfer method should be selected.

According to an embodiment, there is a flowchart 300 which describes step 210 in more detail, i.e., learning a performance model using a source domain, as shown in FIG. 3. Initially, in step 302, a source domain (testbed) and service deployment from the cloud/DC system with the given service configurations provided in step 202 are requested. Then, in step 304, deployment of load generator and monitoring modules to sample the load space are requested. In step 306, machine learning is used to learn the source model in the source domain. In step 308, the source model and source domain configurations are stored, e.g., in a model database.

According to an embodiment, a flowchart 400 describes in more detail how a transfer learning method is determined and used to learn a performance model in the target domain as described above with respect to steps 214 and 216. Initially, in step 402, a transfer learning method is selected, and a target model is created using the source model (either newly learned or an existing performance model) and the selected transfer learning method. The transfer learning method is used for transferring knowledge from, e.g., a linear regression, to another linear regression model. The transfer learning method selects and scales the parameters of the linear regression model in the correct way. In other words, the transfer learning method is a function that is applied to one of linear regression, decision tree, neural networks and random forest. Additionally, the transfer learning function can be to, e.g., transfer weights of the source model to the target model, or the transfer learning function can re-use trees in a tree-based model.

The transfer method selection can, for example, be made starting from a simpler one of the transfer learning methods and iterating, as needed, through more complex transfer learning methods. According to an embodiment, another example of a transfer learning method is to reuse parts of the source model in the target domain. For example, if the source model is based upon neural networks, one or several layers and associated weights of the source model can be transferred to the target model. The transfer methods can be stored in a database accessible by the cloud management system 102.

It will be understood from FIG. 4 and the following description that the process of FIG. 4 involves, among other things, trying different transfer learning methods to generate target performance models until an acceptable target model is learned or all of the transfer learning methods have been attempted but fail to generate an acceptable target model.

Regardless of how a transfer learning method is selected, at step 404, the target model is trained using samples from the target domain. According to an embodiment, the target model can be trained using a subset of samples from the target domain, e.g., 70% of the set of samples. In step 406, the accuracy of the initial target model on the target domain is calculated. The accuracy of the target model is evaluated using the rest of the available samples from the target domain, i.e., in this example the remaining 30% of the samples are used to evaluate the target model. In step 408, it is determined if the calculated accuracy is above a threshold. If the accuracy is above the threshold, then, in step 410, the trained target model is deployed, i.e., the flow proceeds to step 218 in FIG. 2 and this target model is used to predict the performance of the service with the given service configurations.

If, on the other hand, the accuracy of the target model is not above the threshold, then, in step 412, it is determined if another transfer learning method exists, i.e., a different transfer learning method than was used to learn the target model (and different from those used in any previous iteration of the method 400). If the determination is yes, then the process is repeated beginning with step 402, and the selection of a different transfer learning method, to see if a satisfactory target model can be learned. If the determination is no, then a new source (testbed) domain is requested as shown in step 414 and a new source model is learned as described above, i.e., the process returns to step 210 in FIG. 2.

As a working example of the method of FIG. 4, the performance of a service in a source domain can be learned using a random forest model. Then a linear regression model can be selected as a transfer method to transfer the predictions in the source domain to the target domain. To make a prediction for the target domain, first the source random forest model is used to make a prediction and then the predicted value is transferred linearly to the target domain. If the accuracy of the prediction for the target domain is not acceptable, then a different transfer method can be tried instead, for example, trying a non-linear regression model.

While the flowcharts in FIGS. 2-4 illustrate “performance models”, it is to be understood that other types of data driven models could be substituted for the performance models and that these methods illustrated are also applicable to other types of data driven models.

As another example, a neural network can be used for learning the performance of a service in the source domain. In order to transfer the predictions to the target domain, one can select the weights on which layers of the neural network to be re-trained. For example, in a five layer source neural network model, the transfer method can be to reuse the same neural network where the weights of the first three layers are frozen (cannot be trained). The new model is then trained using the samples from the target domain and then is used for making predictions for the target domain. If the accuracy of the predictions is not acceptable then a new transfer method can be selected by freezing the weights of a different number of layers from the source model, e.g., freezing the weights of the first two layers.

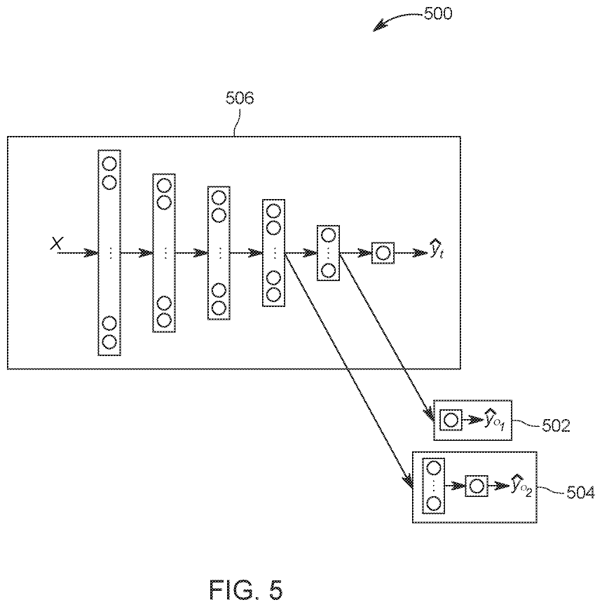

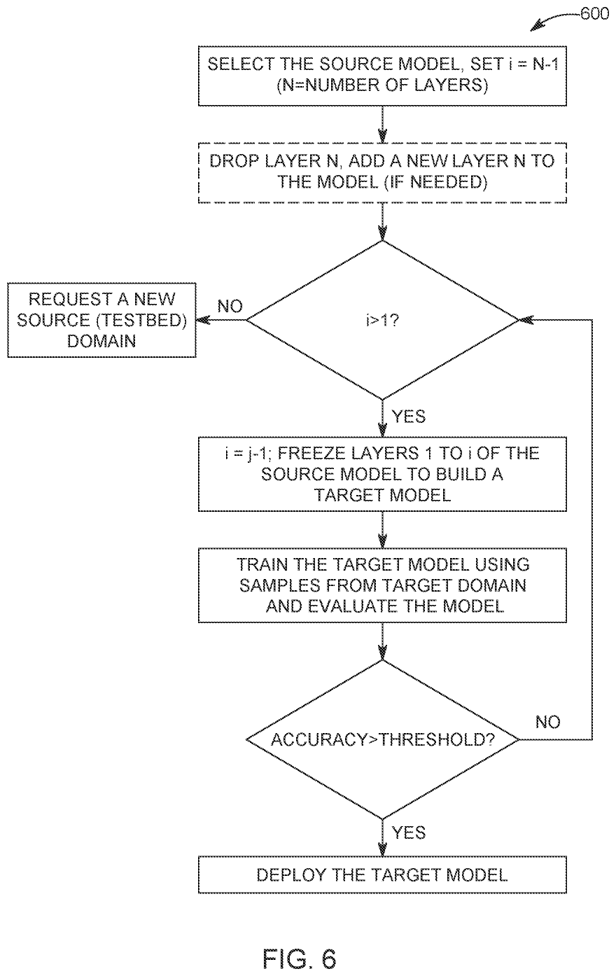

According to an embodiment, FIGS. 5 and 6 illustrate an example where transfer learning is used for a deep neural network. More specifically, the neural network 500 is shown in FIG. 5 and a flowchart 600 illustrating how the correct number of layers to be retrained can be identified is shown in FIG. 6. The original deep network 506 is the source model learned for predicting the performance of the source domain. This base model can then be used for transfer learning and predicting the performance for target domain o1 502 and target domain o2 504. In this example, the target domain o1 502 is very similar to the test domain therefore it is enough to replace the last layer of the source model with a new layer and re-train only the weights on this layer. In this example, the target domain o2 504 is more different than o1 502, so the weights of the last two layers of the source model are re-trained.

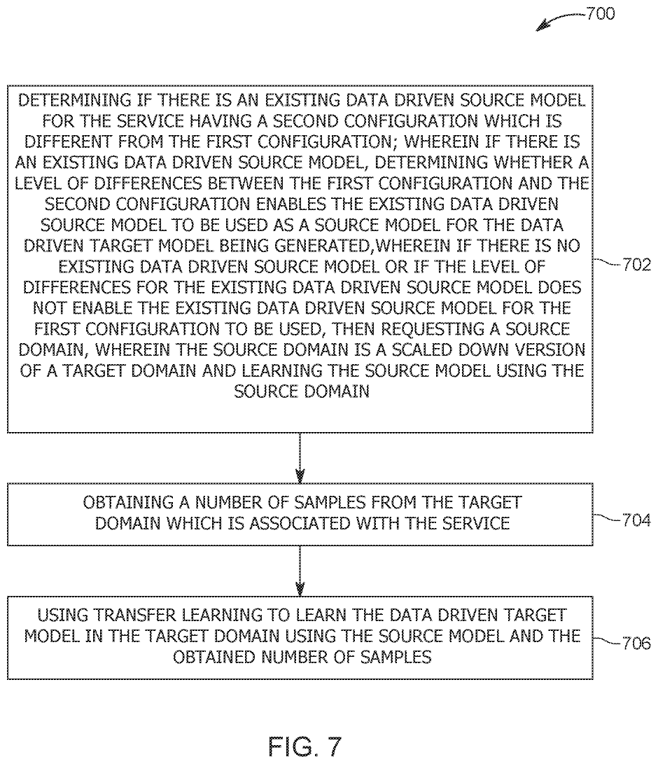

According to an embodiment there is a method 700 as shown in FIG. 7. The method includes: in step 702, determining if there is an existing data driven source model for the service having a second configuration which is different from the first configuration; wherein if there is an existing data driven source model, determining whether a level of differences between the first configuration and the second configuration enables the existing data driven source model to be used as a source model for the data driven model being generated; wherein if there is no existing data driven source model or if the level of differences for the existing data driven source model does not enable the existing data driven model for the first configuration to be used, then requesting a source domain, wherein the source domain is a scaled down version of a target domain and learning the source model using the source domain, in step 704, obtaining a number of samples from the target domain which is associated with the service; and in step 706, using transfer learning to learn the data driven target model in the target domain using the source model and the obtained number of samples.

Additionally, it is to be understood that generating a performance model can also include updating the performance model as new samples arrive in the target domain.

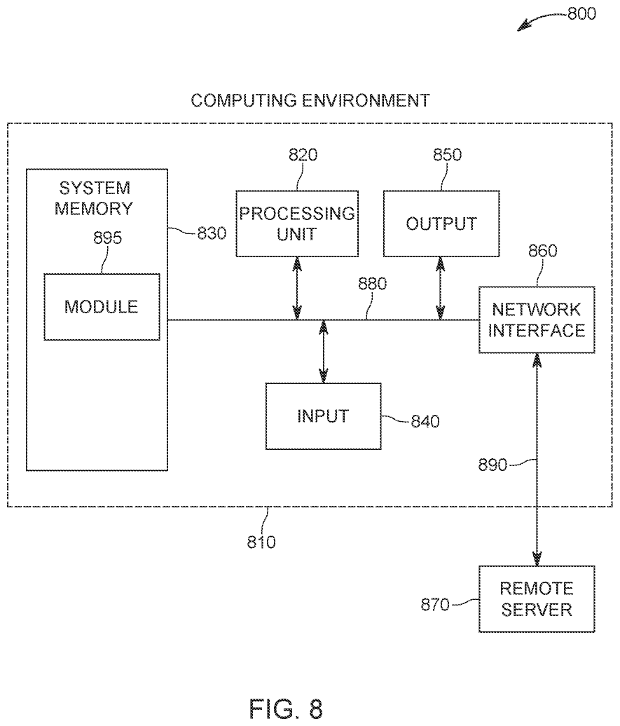

According to an embodiment, the methods described herein can be implemented on one or more servers with these servers being distributed in a cloud architecture associated with an operator network. Cloud computing can be described as using an architecture of shared, configurable resources, e.g., servers, storage memory, applications and the like, which are accessible on-demand. Therefore, when implementing embodiments using the cloud architecture, more or fewer resources can be used to, for example, perform the database and architectural functions described in the various embodiments herein. For example, server 870 (shown in FIG. 8) can be distributed in a cloud environment and can perform the functions of the performance prediction module 104 as well as other servers/communication nodes used in the cloud architecture.

The embodiments described herein can provide various useful characteristics. For example, embodiments described herein allow for faster and cheaper predictions. Embodiments provide for zero or very low interference with operational environment(s) by eliminating the need for extensive measurements to collect data. Embodiments have a very low data collection cost since only a limited sample of data is needed from the operational domain, as data collection in the target domain can be very costly and, in some cases, even infeasible for an operational service. Embodiments also allow for a shorter learning time by transferring knowledge from a source domain to the target domain as, in some cases, there is no need to learn from scratch. For a large-scale operational service, the performance model can be learned on a smaller scale source domain and transferred to the large-scale deployment. Further, since the performance models for the target domain are learned more quickly, the resources are also optimized more quickly, i.e., OPEX is reduced, and there will be fewer SLA violations.

Although as made clear above, computing system environment 800 is only one example of a suitable computing environment and is not intended to suggest any limitation as to the scope of use or functionality of the claimed subject matter. Further, the computing environment 800 is not intended to suggest any dependency or requirement relating to the claimed subject matter and any one or combination of components illustrated in the various environments/flowcharts described herein.

An example of a device for implementing the previously described system includes a general purpose computing device in the form of a computer 810. Components of computer 810 can include, but are not limited to, a processing unit 820, a system memory 830, and a system bus 880 that couples various system components including the system memory to the processing unit 820. The system bus 880 can be any of several types of bus structures including a memory bus or memory controller, a peripheral bus, and a local bus using any of a variety of bus architectures.

Computer 810 can include a variety of transitory and non-transitory computer readable media. Computer readable media can be any available media that can be accessed by computer 810. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media can embody computer readable instructions, data structures, program modules or other data in a modulated data signal such as a carrier wave or other transport mechanism and can include any suitable information delivery media.

The system memory 830 can include computer storage media in the form of volatile and/or nonvolatile memory such as read only memory (ROM) and/or random access memory (RAM). A basic input/output system (BIOS), containing the basic routines that help to transfer information between elements within computer 810, such as during start-up, can be stored in memory 830. Memory 830 can also contain data and/or program modules that are immediately accessible to and/or presently being operated on by processing unit 820. By way of non-limiting example, memory 830 can also include an operating system, application programs, other program modules, and program data.

The system memory 830 may include a software module 895 loaded in the memory and processable by the processing unit, or other circuitry which cause the system to perform the functions described in this disclosure.

The computer 810 can also include other removable/non-removable and volatile/nonvolatile computer storage media. For example, computer 810 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 880 through a non-removable memory interface such as an interface, and a magnetic disk drive or optical disk drive can be connected to the system bus 880 by a removable memory interface, such as an interface.

A user can enter commands and information into the computer 810 through input devices such as a keyboard or a pointing device such as a mouse, trackball, touch pad, and/or other pointing device. Other input devices can include a microphone, joystick, game pad, satellite dish, scanner, or similar devices. These and/or other input devices can be connected to the processing unit 820 through user input 840 and associated interface(s) that are coupled to the system bus 880, but can be connected by other interface and bus structures, such as a parallel port, game port or a universal serial bus (USB).

A graphics subsystem can also be connected to the system bus 880. In addition, a monitor or other type of display device can be connected to the system bus 880 through an interface, such as output interface 850, which can in turn communicate with video memory. In addition to a monitor, computers can also include other peripheral output devices, such as speakers and/or printing devices, which can also be connected through output interface 850.

The computer 810 can operate in a networked or distributed environment using logical connections to one or more other remote computers, such as remote server 870, which can in turn have media capabilities which are the same or different from computer device 810. The remote server 870 can be a personal computer, a server, a router, a network PC, a peer device or other common network node, and/or any other remote media consumption or transmission device, and can include any or all of the elements described above relative to the computer 810. The logical connections depicted in FIG. 8 include a network 890, such as a local area network (LAN) or a wide area network (WAN), but can also include other networks/buses.

When used in a LAN networking environment, the computer 810 is connected to the LAN 890 through a network interface or adapter. When used in a WAN networking environment, the computer 810 can include a communications component, such as a modem, or other means for establishing communications over a WAN, such as the Internet. A communications component, such as a modem, which can be internal or external, can be connected to the system bus 880 through the user input interface at input 840 and/or other appropriate mechanism.

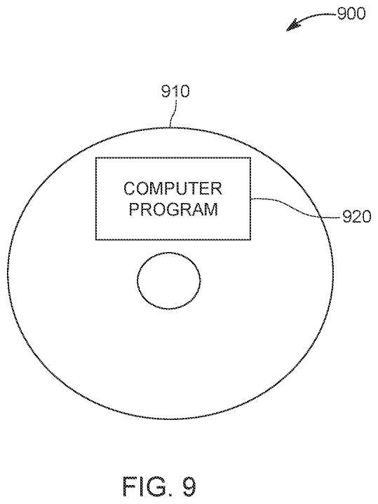

FIG. 9 shows computer readable media 900, e.g., a non-transitory computer readable media, in the form of a computer program product 910 and a computer program product 920 stored on the computer readable medium 900, the computer program capable of performing the functions described herein.

In a networked environment, program modules depicted relative to the computer 810, or portions thereof, can be stored in a remote memory storage device. It should be noted that the network connections shown and described are exemplary and other means of establishing a communications link between the computers can be used.

According to an embodiment, an advantage compared to existing technologies relates to performance and scaling, upgrade scenario, and handle of flexible data models. The performance issue is due to that most of the work related to encoding/decoding and manipulation of data is done in the server in prior art solutions. The server is normally the limiting factor in a database intensive application. The problem with the upgrade scenario is that the server upgrades the schema for all data instances of a specific type at once, and all clients must be able to handle that before the upgrade can be done. The limitation in flexibility is also related to the issue that all instances of a specific data type must have the same schema.

Additionally, it should be noted that as used in this application, terms such as “component,” “display,” “interface,” and other similar terms are intended to refer to a computing device, either hardware, a combination of hardware and software, software, or software in execution as applied to a computing device. For example, a component may be, but is not limited to being, a process running on a processor, a processor, an object, an executable, a thread of execution, a program and a computing device. As an example, both an application running on a computing device and the computing device can be components. One or more components can reside within a process and/or thread of execution and a component can be localized on one computing device and/or distributed between two or more computing devices, and/or communicatively connected modules. Further, it should be noted that as used in this application, terms such as “system user,” “user,” and similar terms are intended to refer to the person operating the computing device referenced above.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various exemplary combinations and subcombinations of embodiments and of the manner and process of making and using them, and shall support claims to any such combination or subcombination.

Many variations and modifications can be made to the embodiments without substantially departing from the principles of the present solution. All such variations and modifications are intended to be included herein within the scope of the present solution.

1. A method for generating a data driven target model associated with a service having a first configuration, the method comprising:
determining if there is an existing data driven source model for the service having a second configuration which is different from the first configuration;
wherein if there is an existing data driven source model, determining whether a level of differences between the first configuration and the second configuration enables the existing data driven source model to be used as a source model for the data driven target model being generated;
wherein if there is no existing data driven source model or if the level of differences for the existing data driven source model does not enable the existing data driven source model for the first configuration to be used, then requesting a source domain, wherein the source domain is a scaled down version of a target domain and learning the source model using the source domain;
obtaining a number of samples from the target domain which is associated with the service; and
using transfer learning to learn the data driven target model in the target domain using the source model and the obtained number of samples.

2. The method of claim 1, further comprising:
receiving a request for predicting or estimating characteristics of the service with the first configuration to initiate the method for generating the data driven target model with the second configuration; and
determining a transfer learning method to use to perform the transfer learning.

3. The method of claim 1, wherein when the level of differences between the first configuration and the second configuration is above a predetermined threshold then the existing data driven source model is not able to be used as the source model.

4. The method of claim 1, wherein the level of difference between statistical properties of the data between the first configuration and the second configuration is above a predetermined threshold then the existing data driven source model is not able to be used as the source model.

5. The method of claim 1, wherein the step of learning the source model further comprises:
requesting a cloud environment;
deploying the scaled down version of the target domain;
requesting deployment of one or more load generators;
collecting data;
training the source model with a machine learning approach and
storing the source model and source domain configuration.

6. The method of claim 1, wherein the step of using transfer learning to learn the data driven target model further comprises:
creating the data driven target model using the source model and a transfer learning method;
training the data driven target model using at least some of the number of available samples from the target domain to generate a trained data driven target model;
evaluating an accuracy of the trained data driven target model on the target domain; and
deploying the trained data driven target model as the data driven model when the accuracy of the trained data driven target model exceeds a predetermined threshold.

7. The method of claim 6, wherein when the accuracy of the trained model does not exceed a predetermined threshold, determining if a different transfer learning method exists and repeating the steps of creating, training, evaluating and deploying using the different transfer learning method.

8. (canceled)

9. The method of claim 1, wherein the data driven target model is one of a performance model, anomaly detection model, and troubleshooting model.

10. The method of claim 6, wherein the transfer learning method is a function that is applied to one of linear regression, decision tree, neural networks and random forest.

11. A communication node configured to generate a data driven target model associated with a service having a first configuration, the communication node comprising:
a processor configured to determine if there is an existing data driven source model for the service having a second configuration which is different from the first configuration;
wherein if there is an existing data driven source model, the processor determines whether a level of differences between the first configuration and the second configuration enables the existing data driven source model to be used as a source model for the data driven target model being generated;
wherein if there is no existing data driven source model or if the level of differences for the existing data driven source model does not enable the existing data driven source model for the first configuration to be used, then the processor requests a source domain, wherein the source domain is a scaled down version of a target domain and learning the source model using the source domain;
wherein the processor is configured to obtain a number of samples from the target domain which is associated with the service; and
wherein the processor is further configured to use transfer learning to learn the data driven target model in the target domain using the source model and the obtained number of samples.

12. The communication node of claim 11, further comprising:
a communication interface configured to receive a request for predicting or estimating characteristics of the service with the configuration to initiate the method for generating the data driven target model with the second configuration; and
wherein the processor is further configured to determine a transfer learning method to use to perform the transfer learning.

13. The communication node of claim 11, wherein when the level of differences between the first configuration and the second configuration is above a predetermined threshold then the existing data driven source model is not able to be used as the source model.

14. The communication node of claim 11, wherein the level of difference between the first configuration and the second configuration is above a predetermined threshold then the existing data driven source model is not able to be used as the source model.

15. The communication node of claim 11, wherein when the processor learns the source model, the communication node further comprises:
the communication interface is configured to request a cloud environment;
the processor is configured to deploy the scaled down version of the target domain;
the communication interface is configured to request deployment of one or more load generators;
the processor is configured to collect data;
the processor is configured to train the source model with a machine learning approach; and
a memory configured to store the source model and source domain configuration.

16. The communication node of claim 11, wherein when the processor learns the data driven target model:
the processor is further configured to create the data driven target model using the source model and a transfer learning method;
the processor is further configured to train the data driven target model using at least some of the number of samples from the target domain to generate a trained target model;
the processor is further configured to evaluate an accuracy of the trained data driven target model on the target domain; and
the communication node is further configured to deploy the trained data driven target model as the data driven target model when the accuracy of the trained data driven target model exceeds a predetermined threshold.

17. The communication node of claim 16, wherein when the accuracy of the trained data driven model does not exceed a predetermined threshold, the processor is further configured to determine if a different transfer method exists and to repeat the steps of to create, to train, to evaluate and to deploy using the different transfer learning method.

18. The communication node of claim 11, wherein the service is performed in a dynamically changing environment which is a cloud environment.

19. The communication node of claim 18, wherein the data driven target model is one of a performance model, anomaly detection model, and troubleshooting model.

20. The communication node of claim 16, wherein the transfer learning method is a function that is applied to one of linear regression, decision tree, neural networks and random forest.

21. A non-transitory computer-readable storage medium containing a computer-readable code that when read by a processor causes the processor to perform a method for generating a data driven target model associated with a service having a first configuration comprising:
determining if there is an existing data driven source model for the service having a second configuration which is different from the first configuration;
wherein if there is an existing data driven source model, determining whether a level of differences between the first configuration and the second configuration enables the existing data driven source model to be used as a source model for the data driven target model being generated;
wherein if there is no existing data driven source model or if the level of differences for the existing data driven source model does not enable the existing data driven source model for the first configuration to be used, then requesting a source domain, wherein the source domain is a scaled down version of a target domain and learning the source model using the source domain;
obtaining a number of samples from the target domain which is associated with the service; and
using transfer learning to learn the data driven target model in the target domain using the source model and the obtained number of samples.

22-25. (canceled)
